(19) United States
(12) Patent Application Publication
(10) Pub. No.: US 2005/0162343 A1
(43) Pub. Date: Jul. 28, 2005

(54) Apparatus and method for improving quality of input image

(75) Inventor: Myeong-hwan Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/025,079

(22) Filed: Dec. 30, 2004

(30) Foreign Application Priority Data
Jan. 8, 2004 (KR) 2004-1089

(51) Int. Cl. G09G 3/20

(52) U.S. Cl. 345/58

(57) ABSTRACT

Apparatus and method for improving quality of an input image. The apparatus includes a contrast module for adjusting contrast of input image data; a luminance module for adjusting luminance of the input image data; and an average picture level detector for calculating an average picture level of the input image data, wherein the apparatus controls more than one of the luminance module and the contrast module based on the average picture level outputted from the average picture level detector to improve the quality of the input image. The image quality can be greatly improved by adding simple algorithm and circuitry.

### BACKGROUND OF THE INVENTION

This application claims priority from Korean Patent Application No. 2004-1089, filed on Jan. 8, 2004, in the Korean Intellectual Property Office, the disclosure of which is incorporated herein in its entirety by reference.

1. Field of the Invention

The present invention relates to an electronic imaging device, and more particularly, to an apparatus and method for improving image quality automatically by calculating a mean luminance value of image data.

2. Description of the Related Art

Due to developments in electronics, technologies in every field are dramatically advancing, and the advancement of image processing technology is prominent among them. Recently, pin-up style display devices such as Liquid Crystal Displays (LCDs), Plasma Display Panels (PDPs), and Digital Light Processing devices (DLPs) have gained popularity, and the performance of display devices is improving while the display devices become lighter. In particular, as digitized display devices become more popular, the need for improving image quality increases. It is apparent that image quality will play a key role in dominating display markets as digital broadcasting becomes increasingly popular.

Various conventional techniques are used to improve image quality. One such technique which is used in an analog display device including Braun tubes involves detecting RGB values of input image signals and controlling the magnitude of electronic beams using the result. The merit of this technique is that image quality can be improved by adding simple circuitry. Conventional image processing techniques can improve image quality by increasing luminance or contrast of the image when the image is too dark. On the other hand, the color reproduction capability can be improved by reducing contrast or luminance of the image when the image is too bright.

However, conventional techniques fail to perform well on dark images since usually the average luminance or the Average Picture Level (APL) is detected and luminance of the image is reduced by a predetermined gain to increase contrast.

Furthermore, conventional techniques cannot be applied to devices which do not use electronic beams. Still, in the case of compensating images by detecting RGB signals of input images, abrupt average picture level variations can result in flickering on a screen, which is bothersome to users.

Therefore, an apparatus which simply improves image quality and can be applied to display devices which do not use electronic beams is needed.

Furthermore, an apparatus improving image quality by minimizing flickering on a screen is required.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

It is an aspect of the present invention to provide an image quality improving apparatus which detects an average picture level of a digital input image signal to improve the image quality.

It is another aspect of the present invention to provide an image quality improving method by minimizing flickering on a screen.

According to an exemplary embodiment of the present invention, an apparatus for improving quality of an input image comprises: a contrast module for adjusting contrast of input image data; a luminance module for adjusting luminance of the input image data; and an average picture level detector for calculating an Average Picture Level (APL) of the input image data, wherein the apparatus controls more than one of the luminance module and the contrast module based on the average picture level outputted from the average picture level detector to improve the quality of the input image.

The apparatus may further comprise: a gamma compensator performing gamma compensation on the input image; and a user control unit controlling a degree of adjustment of at least one of the luminance and the contrast of the input image data based on a user input.

The average picture level detector may calculate the average picture level by repeated calculating operation of calculating an arithmetic mean of an average picture level up to an (n)th frame and a luminance of an (n+1)th frame to generate an average picture level up to the (n+1)th frame for n equals 1 to a predetermined number. The predetermined number is may be set to 6 to prevent flickering on a screen.

According to an exemplary embodiment of the present invention, a method of improving quality of an input image comprises: detecting operation for calculating an average picture level of the input image data; and adjusting at least one of luminance and contrast of the input image based on the average picture level.

The method may further comprises performing gamma compensation on the input image; and controlling a degree of adjustment of at least one of the luminance and the contrast of the input image data based on a user input.

In the controlling of the degree of adjustment, a range of at least one of the luminance and the contrast of the input image data to be adjusted may be controlled based on a user input. The method may further comprise selectively enabling adjustment of the luminance and the contrast based on a user input. Furthermore, the calculating of the average picture level may comprise: calculating an arithmetic mean of an average picture level up to an (n)th frames and a luminance of an (n+1)th frame to generate an average picture level up to the (n+1)th frame, for n equals 1 to a predetermined number. In an exemplary embodiment, the predetermined number may be set to 6 to prevent flickering on a screen.

According to an aspect of the present invention, image quality can be greatly improved by adding simple algorithm and circuitry.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an image quality improving apparatus according to an exemplary embodiment of the present invention;

FIG. 2 is a block diagram of an image quality improving apparatus according to another exemplary embodiment of the present invention;

FIG. 3 illustrates an average picture level calculating operation used in an image quality improving apparatus according to an exemplary embodiment of the present invention;

FIG. 4 illustrates a compensation range of the image quality improving apparatus according to an exemplary embodiment of the present invention;

FIG. 5 illustrates a luminance adjusting operation of the image quality improving apparatus according to an exemplary embodiment of the present invention; and

FIG. 6 is a flow chart illustrating an image quality improving method according to an exemplary embodiment of the present invention.

### DETAILED DESCRIPTION OF THE ILLUSTRATIVE, NON-LIMITING EMBODIMENTS OF THE INVENTION

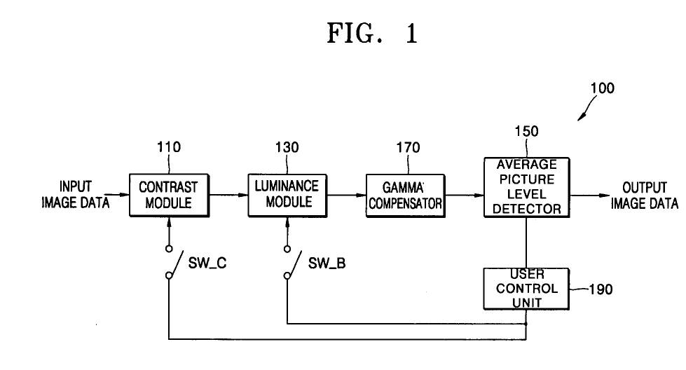

FIG. 1 is a block diagram of an image quality improving apparatus according to an exemplary embodiment of the present invention. Referring to FIG. 1, the image quality improving apparatus 100 includes a contrast module 110, a luminance module 130, a gamma compensator 170, an average picture level detector 150 and a user control unit 190. The image quality improving apparatus further includes switches (SW_C and SW_B) enabling selective control of the contrast module 110 and the luminance module 130 by the user control unit 190.

The average picture level of input image data is detected by the average picture level detector 150. The average picture level can also be calculated by detecting RGB values of a single frame of the input image information. However, flickering due to compensation can occur when image information including abrupt motion changes is processed based on an average picture level of a single frame. Therefore, an average picture level of more than one frame is used rather than an average picture level of a single frame. The operation of the average picture level detector 150 will be described in detail later.

When a mean luminance level of the input image data is detected, contrast and luminance of the image information are compensated using the mean luminance level. In doing so, the user control unit 190 can change the range of the contrast and luminance to be adjusted in response to a user input. For example, a user can select to adjust the luminance by the luminance module 130 only when the average picture level detected by the average picture level detector 150 is smaller than a predetermined level. The user can also select to enable the contrast module 110 to adjust the contrast of the input image data only when the detected mean luminance level is smaller than a predetermined level. The range of the contrast and luminance adjustment will be described in detail later.

Also, the user control unit 190 can select one of the contrast module 110 and the luminance module 130 according to a user input. For example, the user control unit 190 can close one switch (e.g., SW_B) while leaving the other switch (e.g., SW_C) open to deactivate the contrast module 110 when the user selects to adjust luminance only. Furthermore, the user control unit 190 can adjust the degree of compensation, that is operations of change in compensation, of the contrast and luminance of the input image data. For example, a user preferring large changes in the compensation can make the operations of contrast and luminance compensation larger to obtain a desired image. The operation of the user control unit 190 adjusting the steps of compensation will be described in detail later. The gamma compensator 170 performs gamma compensation on the input image.

The image quality improving apparatus 100 in FIG. 1 uses an average picture level which is detected and fedback by the average picture level detector 150 to operate the contrast module 110 and the luminance module 130. However, the present invention is not limited to this configuration, and arrangements in which the average picture level of the input image data is detected and the contrast and luminance are compensated using the detected average picture level can be applied to the present invention.

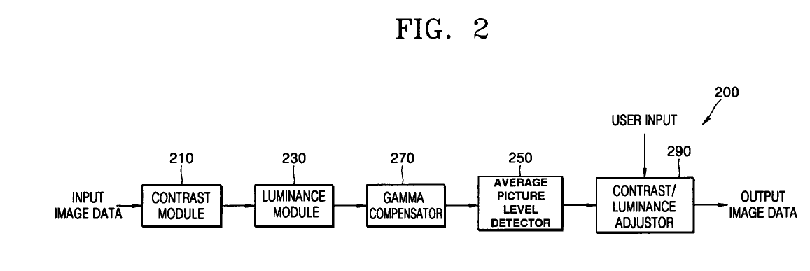

FIG. 2 is a block diagram of an image quality improving apparatus according to another exemplary embodiment of the present invention.

Referring to FIG. 2, the image quality improving apparatus 200 includes a contrast module 210, a luminance module 230, a gamma compensator 270, an average picture level detector 250 and a contrast/luminance adjustor 290. The image quality improving apparatus shown in FIG. 2 includes the contrast/luminance adjustor 290, which compensates the contrast and luminance of the input image data by using the average picture level detected by the average picture level detector 250. That is, the contrast/luminance adjustor 290 receives the output of the average picture level detector 250 to perform contrast and luminance compensation on the input image data. As noted above, the range and degree of the compensation of the luminance and contrast can be adjusted by a user input.

The configuration and operation of the contrast module 210, the luminance module 230, the gamma compensator 270 and the average picture level detector 250 are identical to those of the contrast module 110, the luminance module 130, the gamma compensator 170 and the average picture level detector 150 included in the image quality improving apparatus 100 shown in FIG. 1. Therefore, repeated description is omitted.

Compared to the image quality improving apparatus 100 shown in FIG. 1, the image quality improving apparatus 200 shown in FIG. 2 includes the separate contrast/luminance adjustor 290 rather than using the feedback result from the mean detector 250.

The image quality improving apparatus 200 shown in FIG. 2 performs compensation toward optimal contrast and luminance values, therefore not only is the image brightened, but a gray scaling is also improved when the image is dark. Furthermore, an input image including a saturated region can also be processed to increase the color reproduction capability since the average picture level is calculated considering the saturated area.

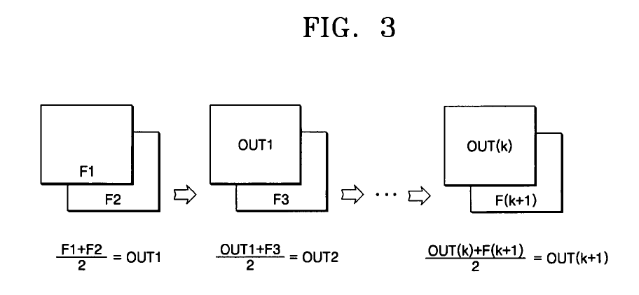

FIG. 3 illustrates an average picture level calculating operation used in an image quality improving apparatus according to an exemplary embodiment of the present invention.

The image quality improving apparatus according to an exemplary embodiment of the present invention uses an average picture level of multiple consecutive input images rather than an average picture level of a single input image, in order to reduce a flickering phenomena even when abrupt variations of the input image data occur. That is, a first frame F1 and a second frame F2 of the input image data are averaged to generate a first output OUT1. Then, the arithmetic mean of the first output OUT1 and a third frame F3 is calculated to generate a second output OUT2. Using a similar algorithm, the arithmetic mean of a (k)th output OUT(k) and a (k+1)th frame F(k+1) is calculated to generate a (k+1)th output OUT(K+1).

By acquiring the average picture level using the operation illustrated in FIG. 3, the average picture level is stabilized even when sudden changes happen in the image, so the flickering on a screen can be reduced. In this case, the adjustment operation is preferably adjusted by 40 ms, which corresponds to two times an inter-frame time interval, 16.6 ms. As the number of frames used to calculate the average picture level is increased, the output average picture level can be stabilized accordingly. However, a time delay due to a calculation load can occur when an excessive number of frames are used for the calculation. Therefore, the number of frames used for the average picture level calculation is to be carefully selected for high speed operation. Based on numerous experiments, it has been determined that an optimal result may be attained when six frames are used to calculate the average picture level.

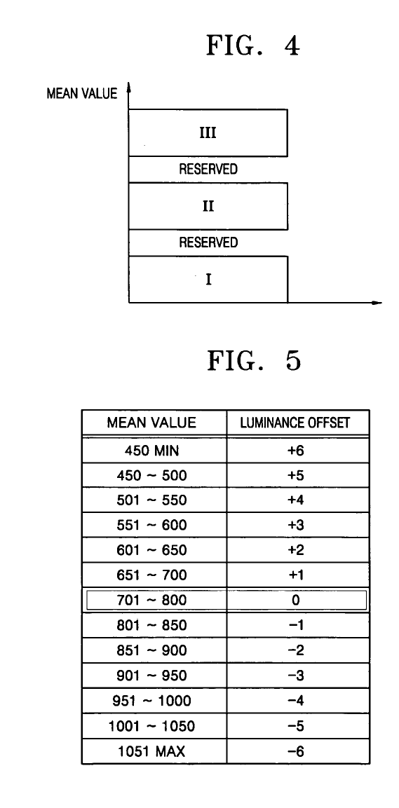

FIG. 4 illustrates compensation range of the image quality improving apparatus according to an exemplary embodiment of the present invention. As shown in FIG. 4, the calculated average picture levels have three categories (I, II, III). A user can select not to perform compensation when the calculated average picture level falls into the second category (II). The user can also select to reduce the contrast and luminance of the input image when the average picture level falls into the third category (III). On the other hand, the user can select to increase the contrast and luminance of the input image when the average picture level falls into the first category (I). As noted above, the compensation ranges can be set in the user control unit 190 in FIG. 1 or in the contrast/luminance adjustor 290 in FIG. 2.

In addition, the user can also enable compensation only when the average picture level is too small or too large. For example, a user who is sensitive to bright images can select to perform compensation on bright images while deactivating the compensation operation on dark images.

Furthermore, a user can also select a compensation range corresponding to a characteristic of the input image data. For example, in the case of a soccer game, images where a green color of a lawn surface dominate, and the user can customize the compensation range in consideration of the color and size of the ball and uniform color of players.

FIG. 5 illustrates a luminance adjusting operation of the image quality improving apparatus according to an exemplary embodiment of the present invention.

The average picture levels shown in FIG. 5 are experimental values which are attained by adding RGB values of an input image data and expressing them as decimal values. As shown in FIG. 5, the degree of luminance compensation is varied according to a range of calculated mean picture levels. When the mean picture level is included in a range of 701 through 800, the luminance is not compensated. On the other hand, when the average picture level is less than 450, luminance is to be compensated by +6. Similarly, when the mean picture level is greater than 1051, luminance is to be reduced by −6. The compensation table shown in FIG. 5 is represented as an example, and is not intended to limit the scope of the present invention. For example, a user who is not sensitive to luminance variation may prefer to compensate the luminance by steps of 3 instead of 1. In this case, the luminance is to be compensated from −18 to +18, rather than −6 to +6 as shown in FIG. 5.

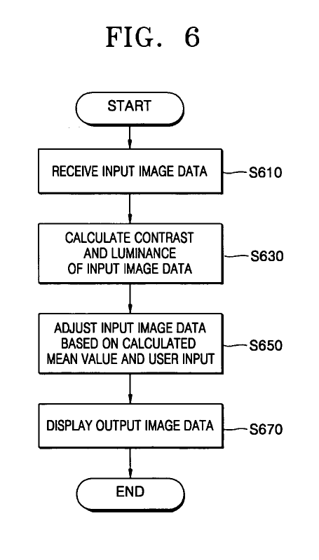

FIG. 6 is a flow chart illustrating an image quality improving method according to an exemplary embodiment of the present invention.

Initially, an input image data is received by an image processing apparatus in operation S610. Then, an average picture level of the received input image data is calculated in operation S630. The average picture level is calculated by one of the average picture level detectors shown in FIGS. 1 and 2.

Then, contrast and luminance levels of input image data are adjusted based on the calculated average picture level and a user input in operation S650. As noted above, the range and degree of compensation of contrast and luminance of the input image data can be adjusted by a user. The contrast and luminance compensation can also be performed by using a fedback average picture level, or can be performed by a separate contrast/luminance adjustor.

Finally, the compensated output image data is displayed in operation S670.

As shown in FIG. 6, the image quality of the input image data is improved by using an average picture level of the input image data.

The image quality improving apparatus according to the present invention can improve the image quality by compensating contrast and luminance of the input image data using an average picture level of digital image signals.

Flickering can be minimized since the apparatus according to the present invention uses more than one mean picture level when compensating the digital image signals to stabilize the output image, even when a large amount of motion occurs in input images.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for improving quality of an input image, the apparatus comprising:
a contrast module which adjusts a contrast of image data of the input image;
a luminance module which adjusts a luminance of the image data; and
an average picture level detector for calculating an average picture level of the image data; and
a control unit which controls at least one of the luminance module and the contrast module based on the average picture level calculated by the average picture level detector to improve the quality of the input image.

2. The apparatus of claim 1, further comprising:
a gamma compensator which performs gamma compensation on the image data, wherein the control unit controls a degree of adjustment of at least one of the luminance and the contrast of the image data based on a user input.

3. The apparatus of claim 2, wherein the control unit controls a range of at least one of the luminance and the contrast of the image data to be adjusted based on the user input.

4. The apparatus of claim 1, further comprising a switch which is selectively closed by the control unit and enables selective control of the luminance module and the contrast module.

5. The apparatus of claim 1, wherein the average picture level detector calculates the average picture level by repeated calculating operation of calculating an arithmetic mean of the average picture level up to an (n)th frame and a luminance of an (n+1)th frame to generate an average picture level up to the (n+1)th frame, for n equals 1 to a predetermined number.

6. The apparatus of claim 5, wherein the predetermined number is 6 to prevent flickering on a screen.

7. A method of improving quality of an input image, the method comprising:
calculating an average picture level of image data of the input image; and
adjusting at least one of a luminance and a contrast of the image based on the average picture level.

8. The method of claim 7, further comprising:
performing gamma compensation on the image data; and
controlling a degree of adjustment of at least one of the luminance and the contrast of the image data based on a user input.

9. The method of claim 8, wherein in the controlling of the degree of adjustment, a range of at least one of the luminance and the contrast of the image data to be adjusted is controlled based on the user input.

10. The method of claim 7, further comprising selectively enabling adjustment of the luminance and the contrast based on the user input.

11. The method of claim 7, wherein the calculating of the average picture level comprises:
calculating an arithmetic mean of an average picture level up to an (n)th frame and a luminance of an (n+1)th frame to generate an average picture level up to the (n+1)th frame, for n equals 1 to a predetermined number.

12. The method of claim 11, wherein the predetermined number is 6 to prevent flickering on a screen.
